(19) United States
(12) Patent Application Publication
(10) Pub. No.: US 2002/0199040 A1
(43) Pub. Date: Dec. 26, 2002

(54) High speed communications device/system

(76) Inventors: David S. Irwin, Kenthurst (AU); Colin S. Lillywhite, Hanover, NH (US); Andrew Betzis, Blakehurst (AU); Mark McDougall, Sans Souci (AU)

Correspondence Address: Elijah Cocks, Choate, Hall & Stewart, Exchange Place, 53 State Street, Boston, MA, 02109, US

(21) Appl. No.: 09/891,843

(22) Filed: Jun. 26, 2001

(51) Int. Cl. G06F 13/28

(52) U.S. Cl. 710/22

(57) ABSTRACT

A system and device are disclosed for the high-speed direct movement of data between remote blocks of memory and between blocks of memory and storage devices. The high speed movement of data is facilitated by a high-speed local bus, and in preferred embodiments, the data undergoes only a single DMA transfer.

### TECHNICAL FIELD

The present invention relates to electronic systems, communication systems, digital devices, such as computers, components of computers or peripheral computer equipment, and the high-speed direct movement of data between remote blocks of memory or storage space using Direct Memory Access (“DMA”).

### BACKGROUND OF RELATED ART

The principal means available today for communicating or moving data between electronic or communications systems have not kept pace with the performance improvements of the electronic and communication systems. These systems include, for example, computer systems and digital storage systems or devices. Presently available systems for moving data, such as communications and I/O systems, have significant disadvantages including low data transfer rates, limited connectivity and significant latencies.

These disadvantages are particularly exacerbated in high performance environments where the slow data transfer rates can make relevant applications impossible regardless of the performance of the system on which they are run. Thus, a need clearly exists for an improved communications or I/O system which is able to overcome, or at least ameliorate, the disadvantages of presently known communications or I/O devices and systems.

### SUMMARY OF THE INVENTION

The present invention provides a system and device for the high-speed direct movement of data between remote blocks of memory and between blocks of memory and storage devices. The high speed movement of data is facilitated by a high-speed local bus, and in preferred embodiments, the data undergoes only a single DMA transfer.

According to one aspect, the present invention is a communications system, wherein data of arbitrary size and under the control of a driver, is transferred directly between a system memory and one or more devices via a system bus, a device system interface, and a local bus. In one embodiment, the device may be a storage device, an add-in PC card, a remote storage device, a storage sub-system of a device, or a second computer system having system memory.

In another embodiment, the driver facilitates the transfer of data of arbitrary size between: relevant sections of the system memory and relevant sections of the device(s); the system memory and a second system memory; remote blocks of memory within the system memory and the blocks of memory of the device using DMA scatter gather lists; and the system memory and the device. In another embodiment, one block of memory is located within the system memory and a second block of memory is located within a storage sub-system of the device(s). In the storage sub-system of the device, it can be provided that the second block of memory may comprise RAM memory. Furthermore, each storage sub-system may be seen as a unique storage unit by the local bus.

In another embodiment, the local bus can support a combination of multiple device system interface modules and multiple other devices such as a DMA controller. The other devices may comprise multiple storage sub-system devices.

In yet a further embodiment, the local bus can be used to provide high-speed communication between local or remote blocks of data stored in the system memory and the device by having DMA combine data transfer and status reporting in one linked transaction. The device, for example, may comprise a storage device and contain standard storage media such as magnetic media (hard disks, floppy disks, etc) and silicon media (ROM, RAM, EEPROM, FLASH EEPROM, etc). The local bus can provide communication between any remote memory block that supports transfer of data of arbitrary size. The local bus can also provide communication between remote memory blocks that have dedicated channels for transmission of data in each direction.

In preferred embodiments, the system bus utilizes the fastest available data transfer channel. In one embodiment, the system bus comprises a PCI bus. In another embodiment, the system bus comprises a PCIX, NGIO, Infiniband, or similar system I/O bus or architecture.

In yet a further embodiment, the device system interface translates system bus signals to local bus signals to accommodate a difference in signalling standards. The signalling standards can include, for example, voltage regulation, memory addressing and cycle timing.

According to another aspect, the present invention is a device for the high-speed direct movement of data of arbitrary size between remote blocks of memory within the device and a system memory provided by a host computer system that comprises one or more blocks of memory, a device system interface, a local bus for the transfer of data between the device system interface and a block of memory of the device. The blocks of memory are remote from the bock of memory provided by the system memory, and the device system interface is provided as either housed in the device or external to the device, but associated with the host computer system. The device system interface is capable of connecting to a system bus of the host computer system to provide for the transfer of data between the system memory and the device system interface. The local bus facilitates the direct movement of data and the data undergoes only a single DMA transfer.

The device can be a storage device provided with storage sub-systems, each of which is provided with memory storage means. Furthermore, the device may be a PCI add-in card, or a device provided external to the host computer system. Accordingly, the present invention seeks to provide these and other features providing a system and device for the high-speed direct movement of data between remote blocks of memory, and blocks of memory and storage devices.

Additional advantages and novel features of the invention will be set forth in the description that follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

For a more complete understanding of the present invention, reference is made to the following description, merely illustrative of an embodiment thereof, described in connection with the accompanying drawings in which:

FIG. 1 provides a schematic of the main functional blocks according to an embodiment of the present invention.

FIG. 2 provides a schematic of the main functional blocks according to a different embodiment of the present invention.

FIG. 3 provides a block diagram of a remote device providing a storage sub-system.

FIG. 4 illustrates the internal wiring of the UPS for the remote device.

FIG. 5 illustrates two storage sub-systems in a lRU drawer for the remote device.

### DETAILED DESCRIPTION OF VARIOUS EMBODIMENTS

I. Overview

The present invention provides for high speed communication on the order of several times that currently available. Alternatively, the present invention provides a means to connect two or more computer system memories, thus enabling the computer system memories to exchange data at high-speed. In one embodiment, a generic Peripheral Component Interconnect (“PCI”) add-in card is provided that communicates via a local bus to either a local block of memory on the add-in card or one or more remote blocks of memory over a local bus. The blocks of memory are used as data storage areas for computer systems or other electronic systems.

In preferred embodiments, the PCI card comprises interface hardware or firmware to operate as a Plug and Play PCI card. One embodiment of the present invention makes it possible to provide a high-speed secondary storage device for applications requiring very fast response time and transfer rates from storage sub-systems. When the PCI computer interface card is connected to remote blocks of memory via the local bus a very scalable system is created. The storage system created responds to system requests at a rate beyond any known storage system.

In another embodiment, a remote device is provided, which houses data storage areas. This remote device connects to a computer system via a PCI card, which provides the necessary hardware or firmware requirements.

II. Modules

The following modules are described as applied to the written description and appended claims in order to provide a more precise understanding of the subject matter of the present invention.

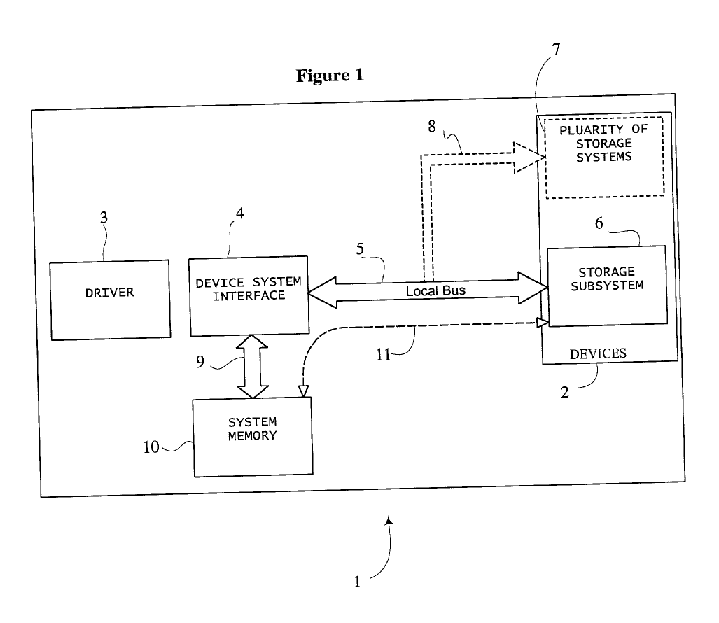

Reference will now be made to FIG. 1, which illustrates a communications system 1. In one embodiment, this system may be embodied as an add-in PCI RAM card. In this embodiment, the on-card memory is not mapped into PCI address space, but instead, the RAM is accessible to the host PC via a set of control registers mapped into PCI address and/or PCI I/O space.

The system 1 supports data transfer speeds to and from the memory devices 2 at full PCI band-widths via burst transactions of limited size. The system 1 can also support ECC memory and is capable of generating PCI interrupts. In a preferred embodiment, the system comprises five main functional modules: a Device Driver 3, a Device System Interface 4, a Local Bus 5 (and 8 if sub-systems 7), a Storage sub-system 6 (or storage sub-systems 7) and a Power System (not shown).

Also shown in FIG. 1 is the bus 9 on the host system incorporating the system memory 10. Pathway 11 illustrates the high-speed data path between the remote memory blocks 10 and 6 (and 7).

The following description highlights the function of each of these modules. There is no single physical architecture implied by the functional description, and such functionality from each conceptual module may be integrated or distributed amongst several physical devices.

Device Driver

The device driver 3 facilitates the transfer of data between two storage sub-systems (6 and 10) over the local bus 5. This is achieved by using a scatter gather technique to create one single DMA transfer, of arbitrary size, for each request to transfer data.

Several advantages are realized by having the transfer be of arbitrary size as opposed to being limited to a packet size. For, to achieve high performance using packets, the use of large packets would be optimal. This is because less set up time would be required for the overall transaction. However, this in turn increases the need for buffers to retain these packets before they can be transmitted. The arbitrary data transfer size of the present invention is thus superior to the use of packets. First, there is only one set-up and initialization routine required for a complete transfer. Second, there is no latency incurred in waiting for a full packet to be ready, and the need for buffers to retain the packet is negated within the system.

By using scatter gather lists, the transfer of data between non-contiguous blocks of memory can occur in one linked transaction. The bank select and error reporting registers are mapped into a memory space. Furthermore, any accesses to registers that are required in the transaction are calculated by the driver and inserted in to the DMA scatter gather list. This increases performance by allowing the transfer to occur in one transaction without having to stop or break to allow accesses to these registers.

To maximize the virtual address space on the local bus 5, address-decoding logic uses the data access width to determine the target virtual address space. Data accesses across the PCI bus of 8, 16, 32 or 64 bits allows the mapping of three (3) distinct virtual address spaces onto the local bus 5. The driver 3 allows a generic or standard system interface to be used in multiple systems and can be customized for each system to provide maximum performance.

Device System Interface

The device system interface 4 connects the system memory 10 to the local bus 5 in a transparent and portable manner. In a preferred embodiment the device system interface 4 is a PCI interface comprising a PCI Bus Master controller and DMA engine. The PCI interface is capable of arbitrating for bus ownership in order to facilitate burst transfers to and from the memory using the DMA engine. The interface handles all aspects of PCI bus control, including cycle generation, interrupt generation and all other physical signalling required by the PCI Local Bus Specification. (See PCI Bus Specification, Rev 2.2).

The DMA engine is capable of initiating a DMA transfer, i.e. the DMA engine is capable of arbitrating for bus ownership via the PCI Interface. The DMA engine maps a number of control registers into PCI memory and/or PCI I/O space and DMA operations are controlled via this register interface. The DMA engine supports data transfers across the PCI bus between the remote memory and the host memory. The DMA engine is capable of resuming interrupted transfers (due to bus contention, for example) and terminating bus transactions under exception conditions. Transaction completion raises a PCI interrupt via the PCI Interface.

The Local Bus

The local bus 5 is a high-speed bus used for communication between storage sub-systems 6 and 7 and interfaces (eg. 4). The local bus 5 supports the transfer of data of arbitrary size. To improve speed the local bus 5 provides dedicated channels for transmission of data in each direction. The local bus, for example, may be physically embodied as a LVDS cable or fibre optic cable.

Storage Sub-system

The storage sub-system 6 of the device 2 can be any storage system. Some illustrative examples include, storage media, magnetic media (hard disks, floppy disks), silicon media (ROM, RAM, EEPROM, etc.), main memory of another system, and SAN and NAS systems. The storage sub-system 6 comprises an interface to facilitate the transfer of data between the local bus 5 and the memory within the storage sub-system. There can be multiple storage sub-systems 7 connected to the local bus 5 (via 8).

In a preferred embodiment, the storage sub-system 6 is an SDRAM controller and a number of SDRAM modules. The SDRAM modules provide the necessary low latency and high-speed data transfer to make full use of the other components in the system. The SDRAM controller services access requests to the SDRAM from the DMA engine via the local bus 5. Hence the controller is responsible for the initialization, access and refresh cycles required for SDRAM operation. The controller also facilitates access to SPD EEPROM on the DIMMs.

The controller also dictates the mapping of SDRAM into the local bus address space. There is no requirement for memory to be mapped into a single, contiguous block. The algorithm used to determine memory mapping is ‘known’ to the host device driver software and the mapping may be derived implicitly from this knowledge and the configuration read from the DIMM SPD EEPROMs.

The controller facilitates ECC support for SDRAM DIMMs with this capability. The controller generates ECC check bits for writes to SDRAM and performs error detection and correction on the fly for reads from SDRAM. Exception conditions are reported to the OS by the driver. By design, the controller organizes I/O operations in to multiples of quad words (64 bits). Hence, there is no requirement for the controller to perform read-and-write-back operations when transferring data to local SDRAM to calculate ECC check bits. This improves performance by only performing one write, with ECC check bits calculated on-the-fly, rather than having to do a partial read and write to the SDRAM.

The SDRAM DIMMs comprise unbuffered, buffered or registered DIMMs (See, e.g., PCSDRAM Registered DIMM Design Support Document, Intel, Rev 1.2; see also, PC SDRAM Unbuffered DIMM Specification, Intel, Rev 1.02). The DIMMs are mapped into local bus address space by the controller without regard for a requirement to have a single, contiguous memory map. The DIMMs may, for example, be any combination of 16, 32, 64, 128, 256, 512 or 1024-megabyte modules, but are not limited to these sizes. The number of rows, columns, row-select and banks of the various DIMMs are not known until they are read from the DIMMs SPD EEPROMs. The rows, columns, banks and row-select lines of the SDRAM DIMMs are mapped directly onto the virtual (logical) address lines. The resulting virtual address space is non-contiguous, requiring the device driver to re-map addresses on-the-fly, to present a contiguous address space to the host system. Installation of non-ECC modules in any slot on the card disables ECC functionality for the entire memory array.

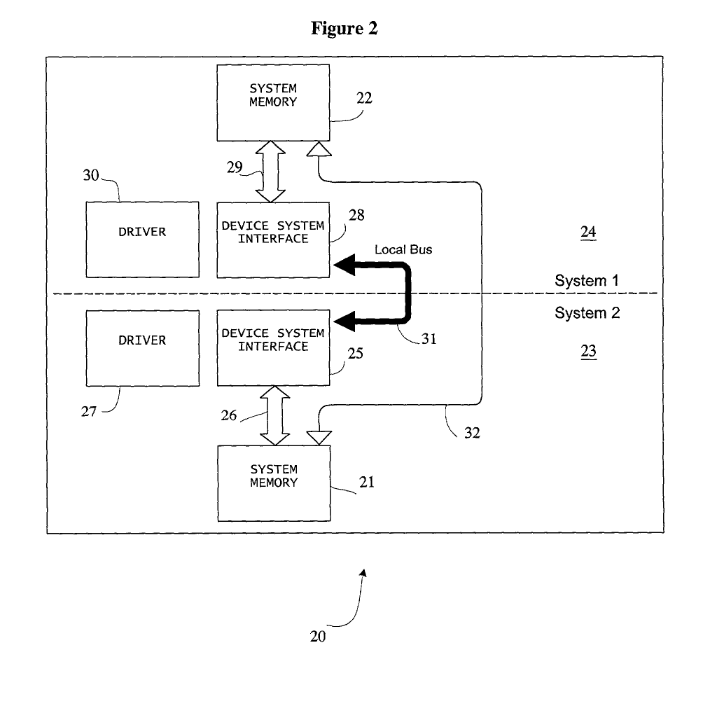

Referring now to FIG. 2, an alternative embodiment of the present invention is illustrated. The communications system 20 comprises a system memory 21 and a further system memory 22. The system memory 21 and 22 are part of a separate computer systems 23 and 24 respectively. The device system interface 25, the bus 26, and the driver 27 are associated with the computer system 23 and allow for the transfer of data to and from the system memory 21. Likewise, the device system interface 28, the bus 29, and the driver 30 are associated with the computer system 24 and allow for the transfer of data to and from the system memory 22. In this embodiment the local bus 31 provides the communications pathway between the system memories 21 and 22. The high-speed data path 32 between the memory blocks (21 and 22) is also illustrated.

III. Examples

The following examples provide a more detailed outline of one particular embodiment of the present invention as a device. These examples are intended to be illustrative only and not limiting in scope.

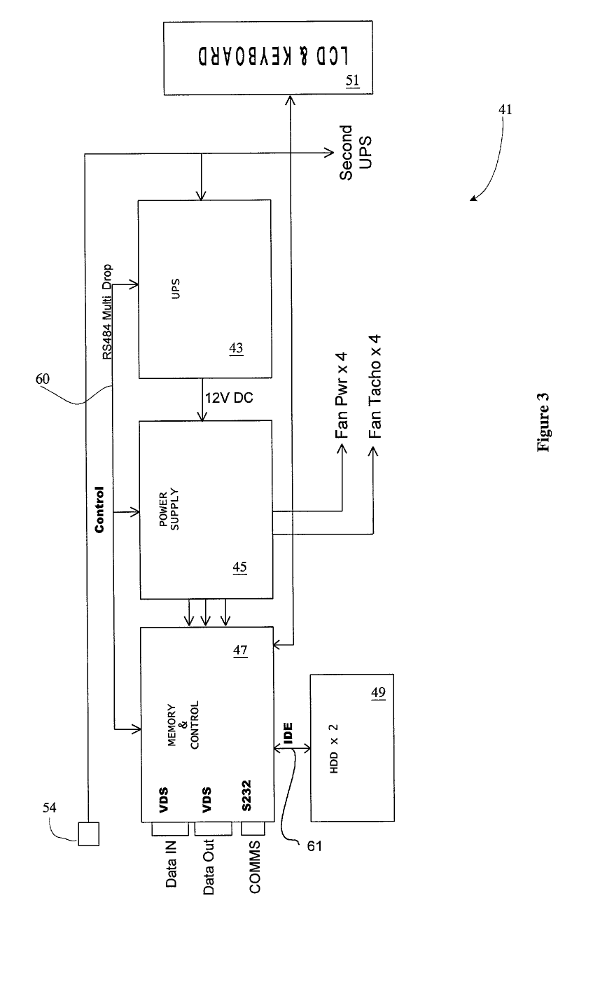

Reference will now be made to FIGS. 3, 4 and 5. In one embodiment, the present invention provides a data transfer device 40 to deliver a cost effective product that delivers very high performance in a very reliable package. The device 40 has no data volatility issues, this being made possible by the multiple levels of redundancy within the device. In the event of device failure, users would be able to reliably recover data stored on the data transfer device as with a normal hard disk drive.

Performance should be a sustained data transfer rate in excess of 300 MB /sec, more than 25,000 2K OLTP transactions per second and a response time in the order of 25 microseconds. Integration into a system should be no more complex than the integration of a RAID/HDD based storage system. The device 40 should monitor its own status and report faults or warn of pending problems requiring service. The data transfer device technology should readily connect to planned NAS and SAN storage management systems via another embodiment of the device system interface.

Data Transfer Device Overview:

The data transfer device 40 is a high performance scalable solid state storage system that can be configured to offer a high level of data protection against an internal failure. The level of data protection implemented is user configurable to meet individual requirements. The basic building block of the data transfer device storage system is a one Rack Unit (lRU) drawer containing two independent storage sub-systems 41 and 42. Each storage sub-system comprises a UPS module (43 and 44), Power supply module (45 and 46), Memory, control and I/O module (47 and 48), HDD archive module (49 and 50) and Display module (51 and 52).

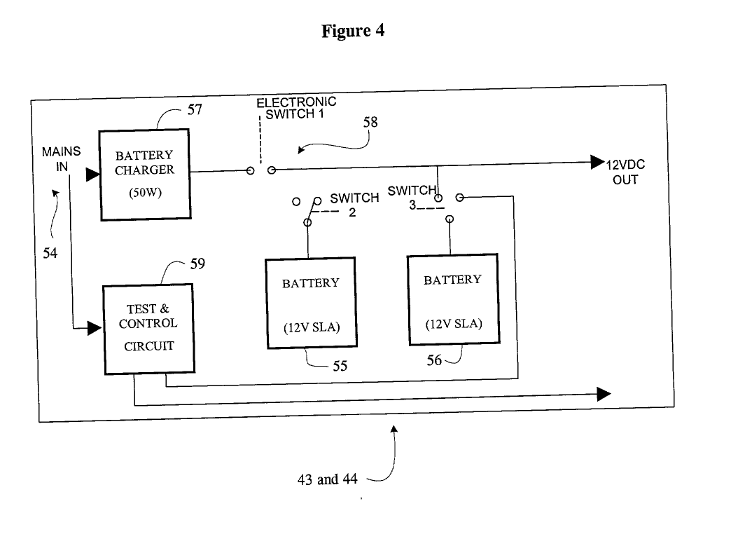

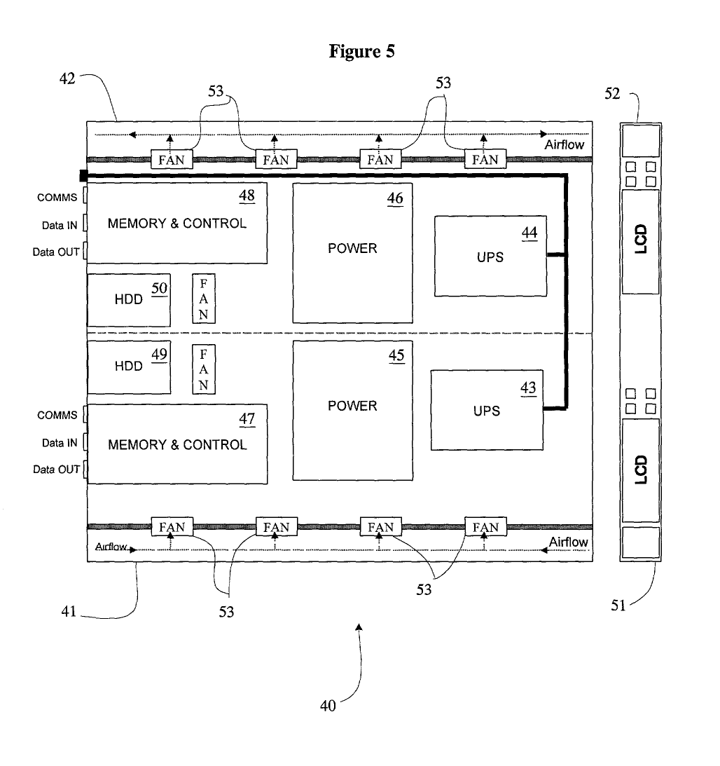

The data transfer device 40 connects to the host system via a separate PCI Adaptor card. The PCI adaptor card communicates with the data transfer device storage units (47 and 48) via a pair of 68 way twisted pair cables. FIG. 3 shows interconnection of each module within a single storage sub-system. FIG. 4 shows a schematic for the provision of power for the device 40. FIG. 5 shows how two storage sub-systems fit into a lRU drawer. The following provides an overview of the 1RU data transfer device drawer and each module within a single storage sub-system (41 or 42).

1RU Storage Sub-system Features

Each 1RU drawer contains two independent storage sub-systems (41 and 42). Each storage sub-system is uniquely identified on the communications loop and appears like a new drive, as would a mechanical drive being added to as SCSI controller. The individual storage sub-systems or drives on the communication loop can be spanned etc. by standard OS utilities as with mechanical hard disk drives.

Field Programmable Gate Arrays (FPGA) are used in the data transfer device to add a level of device support not possible with other logic families. The FPGAs allow the device's logic to be upgraded in the field. This upgrade or customisation is achieved by distributing a new revision of the driver to upgrade the FPGA on the system interface card. To upgrade the FPGA logic or firmware of the storage sub-systems in a 1RU drawer requires connection to another PC, typically a laptop, via a serial or other type of interface. Alternatively, the upgrade file may be copied into the storage space of each storage unit, where it is recognized as an upgrade and loaded into the system.

To deliver performance the data transfer device storage system reads and writes data to RAM. Data stored in RAM is valid only while power is maintained. In the event of power loss data stored in the RAM has to be moved or archived to a storage mechanism not dependant on external power. This secondary storage mechanism is provided by a mirrored set of removable 2.5″ IDE drives. There are two mechanical drives because they have moving parts and their reliability is nowhere near as good as that of the rest of the storage unit. The 2.5″ drives are periodically powered up if they have not been used for an extended period of time to examine their status.

In the event of external power loss, power to enable a backup of data in RAM to the internal hard disk drives is provided by batteries. These batteries have enough stored power ensure several consecutive archiving processes without any recharging. The batteries are fully recharged once main power is restored. Battery condition is monitored by the on-board diagnostic system. A warning is given if the batteries need replacing. The backup of blocks of data to the HDD's is based on a dirty block tag stored in RAM and on the HDD's. This means that only blocks of data in RAM that have changed from what is stored on the HDD's are backed up. This can reduce the backup time and the power consumed during a backup.

When power is first applied to the data transfer device there is no data in the RAM array. The on-board CPU immediately starts copying blocks of data from the HDD's to RAM. As the host system requests blocks of data, they are either retrieved from RAM or from the HDD's if they are not yet in RAM and forwarded to the host system. Requested blocks of data not yet in RAM are copied to RAM at the same time they are sent to the host system.

System Resets have no impact on data stored in the data transfer device. The drive will go offline and into a power save mode while the system is resetting. As the OS comes back up and reloads the driver, the drive will come on line again. Data in RAM is not affected and is available instantly. The data transfer device will only go into a backup mode when it has detected loss of external power. The data transfer device 1RU drawer is connected to external power via a standard IEC power cable.

To ensure that there is no heat build-up in the 1RU data transfer device storage unit, multiple fans 53 force air through the unit. Fan and 2.5″ drive failures are detected by the firmware. Heat sensors located on the main board monitor heat levels in the unit and warn of excessive heat build up.

Each storage sub-system can support up to 8 GB of SDRAM or a total of 16 GB per 1RU unit. The metal components of the 1RU drawers are electro-less nickel plated. The unit has a milled and anodised aluminium front bezel. The 1RU unit will comply with C-Tick, FCC and CE radio interference and safety standards.

UPS Module: The Un-interruptible Power Supply 43 and 44 (UPS) has a universal main AC input 54 of 85 VAC to 264 VAC. Each internal 12 Volt Sealed Lead Acid (SLA) battery 55 and 56 has a one hour discharge rate of at least 1.75 AH. The output of the UPS 43 or 44 is a nominal 13.8 VDC. The UPS provides an output signal to indicate loss of main power 54.

FIG. 4 shows a simplified view of the internal wiring of the UPS. The output of the battery charger 57 has two 12 V 2 AH SLA batteries 55 and 56 connected to it so as to have the batteries in a floating/trickle charging configuration. For design purposes the output of the UPS is considered to be 9 V to 16 V DC with a nominal voltage of 12 V DC.

The battery charger 57 is isolated from the batteries by an electronic switch 58 to prevent it acting like a load when main power is lost. Each battery can be individually isolated from the main power rail and connected to a test circuit 59. The test circuit 59 can determine the batteries 55 and 56 condition and state of charge, which is reported back to the firmware running on the main CPU. One battery is tested at a time to ensure there is always a battery on line to provide power in the event of mains power loss. Battery Cycles are also counted to determine if they require replacing.

Power Supply Module:

The power supply module 45 has as its input the nominal 12 V DC that is the output of the UPS 43. The power supply module 45 derives the three output power rails from the 12 V input rail through the use of high efficiency DC to DC converters. Being high efficiency converters these unit dissipate very little of the input power as heat. Each individual DC/DC converter is available as a high quality off the shelf part. Power for all cooling fans is distributed directly from the power supply module.

Tacho inputs from each fan are fed back into the power supply module. The outputs from the tacho inputs from each fan are fed into a register that is constantly updated. This register is interrogated at regular intervals by firmware running one the CPU located on the memory and control module.

Memory, Control & I/O:

This module 47 implements five main functions and comprises a DRAM storage array, a LVDS Interface, an IDE interface, a System control, and Error management.

DRAM storage array

The DRAM array is based around eight 72bit wide 168pin un-buffered PC100 compliant DIMM modules. DIMM sizes supported are 128 MB, 256 MB, 512 MB and 1 GB. The DRAM controller is implemented as a logic block within an Altera FPGA. The main functions of the DRAM controller comprise DIMM selection, Address generation, ECC bit generation, ECC bit checking and bit correction, and Writing and reading long words to and from the memory array.

All parts of the storage sub-system 40 that have a low MTBF have been duplicated to improve overall system MTBF. However to give a guarantee of a high level of non-volatility for data stored in the system there must no single point of failure. This can be achieved by configuring the data transfer device storage unit as a fully Duplexed RAID I (mirrored) system.

LVDS Interface

Low Voltage Differential Signalling or LVDS is the method selected to move data from the PCI adaptor to each storage sub-system 41 and 42. The LVDS interface is capable of running at 500 MB/sec over a 68 way twisted flat cable 5 meters in length. There are two of these cables, one is used for sending data from the interface card to the storage unit. The other is used to send data from the storage units back to the PCI adaptor card.

This scheme forms a communication loop or ring. Data can be thought of as travelling in one direction on this communication loop. Each additional storage unit is added to the communication loop by having the input data path connected to the output data path of an existing unit. The output cable that was in the existing unit is moved to the output port of the storage unit being added. The LVDS cabling scheme is designed to connect up to 16 storage sub-systems. Each data transfer device storage sub-system is uniquely identifiable on the communication loop.

IDE Interface

Referring now to FIG. 3, the HDD archive module 49 is connected to the Memory Control & I/O module 47 via an IDE interface 61. The IDE interface 61 is controlled by the embedded 16 bit CPU located in an FPGA on the Memory Control & I/O module 47. This interface is designed to connect to two IDE drives. The connection to each drive is via standard 40pin IDE interface cable. The standard 40pin wiring is converted to the standard used by the 2.5″ drives by a back plane into which the drives plug. Each block of data being backed up is sent to both drives. If a write to one of the drives fails, it is retried several times. If it is still unsuccessful, an error message is reported through the different mechanisms available. Blocks of data are read from one drive only. If a read from the master drive fails it is retried. After several failed attempts the drive is reported as faulty through the different mechanisms available. The drives are asked to report on their status by the system control unit on a regular basis. This information is reported by the error management mechanisms under control of the system control unit. The IBM 2.5′ drives, that may be used, for example, run at 7,200 RPM.

System Control

The system control block (of 47 and 48) has several activities to manage, including: the backup of data to HDD; the restoring of data from HDD; the detection of conditions resulting in warnings, faults or errors; the collection of and display of status information; the collection of statics; and the system testing and diagnosis under control of the system key pad.

Error Management

With reference now to FIG. 5, one of the functions of the system control block 47 is that of monitoring the status of each module within a storage sub-system 41. In the event of a warning, fault or error (correctable or un-correctable) being detected it is reported via several mechanisms. Warnings, faults, errors and status are displayed on the LCD display 51 for that storage sub-system 41 and logged into a log file. In the event of a warning, fault or error an audible alarm will sound. The alarm has a mute option that can be activated once the event generating the alarm has been acknowledged. The mute function has a time out on each alarm generated. Warnings, faults, errors and status can be sent via an SNMP agent to remote monitoring points. Errors may be: reported via a SNMP agent; reported via a written log to the file; transmitted over an external RS232 channel; displayed on the LCD; or cause the alarm to sound.

HDD Archive Module

This module 49 consists of two 2.5″ hard disk drives mounted in a removable frame. The assembly is designed to quickly unplug from the 1RU drawer. This is so the drives can be connected to another system to recover data or the whole assembly can be inserted into another 1RU data transfer device storage unit. The connection to the drives is via a standard 40 pin IDE cable. An adaptor circuit is mounted in the drives mechanical assembly that converts the standard IDE interface to that used by the 2.5″ drives. As with standard 3.5″ drives, power is supplied to the drive assembly by a standard 4 pin power connector.

Display Module

Each data transfer device storage sub-system 41 and 42 has its own LCD display and controlling buttons 51 and 52 for the purpose of displaying information. The information that can be displayed includes status information, performance information and product information. The status information may comprise information such as, battery status, battery fault prediction, SDRAM status, HDD status, HDD fault prediction, I/O status, backup % status, free space, used space, fan status and temperature. The performance information may comprise information such as, I/O performance, bytes per second, transactions per second, HDD performance, and average backup time. The product information may comprise information such as, drive size, vendor ID, product ID, serial number, product storage capacity, product interface speed, and firmware revision.

There may be buttons on the display for example to help scroll through the provided information. For example, in one embodiment (ₛₑₑ FIG. 5), buttons one and two are used to step up and down through the menu while button three selects a function and button four clears a function.

PCI Adaptor Card

The PCI adaptor card (not shown) supports all PCI standards up to 64 bit 66 MHz. The IRU storage unit and the PCI adaptor card communicate over a twisted pair cable using Low Voltage Differential Signalling (LVDS). There are two of these cables, one is used for sending data from the interface card to the storage units. The other is used to send data from the storage units to the PCI adaptor card. This scheme forms a communication loop or ring. Data can be thought of as travelling in one direction on this communication loop. At some point in the future this copper cable will be replaced by fibre optic cable. If the data transfer rate is not pushed much beyond 300 MB /sec the loop described above could be contained in a single cable.

Each data transfer device interface card (or device system interface) can be uniquely identified on the PCI bus. One data transfer device PCI adaptor card can be used to connect several of the storage sub-systems 41 to the host system. The planned maximum is presently sixteen storage sub-systems 41 or 8 fully utilized 1RU draws 40 per PCI adaptor card. Each additional storage unit is added to the communication loop by having the input data path connected to the output data path of an existing unit. The output cable that was in the existing unit is moved to the output port of the storage unit being added.

Connection to the PCI adaptor card is made via two very high-density SCSI connectors located on the PCI cards metal support bracket (end plate). The PCI adaptor card has two functional blocks. One handles the PCI interface and the other handles the LVDS communications. Most of the logic on this card is implemented in an Altera FPGA. Additional logic includes the LVDS driver circuits with cable skew compensation etc.

Thus, the present invention provides a system and device for the high-speed direct movement of data between remote blocks of memory, and blocks of memory and storage devices which satisfies the advantages set forth above. The invention may also be said broadly to consist in the parts, elements and features referred to or indicated in the specification of the application, individually or collectively, in any or all combinations of two or more of said parts, elements or features, and where specific integers are mentioned herein which have known equivalents in the art to which the invention relates, such known equivalents are deemed to be incorporated herein as if individually set forth.

Although one embodiment has been described in detail, it should be understood that various changes, substitutions, and alterations can be made herein by one of ordinary skill in the art without departing from the scope of the present invention as hereinbefore described and as hereinafter claimed.

What we claim is:

1. A communications system for high-speed direct movement of data of arbitrary size between remote blocks of memory comprising:
a system memory, providing a block of memory and housed in a host computer system;
a device, providing one or more further blocks of memory, the further block(s) of memory being remote from the block of memory provided by the system memory;
a device system interface;
a system bus for data transfer between the system memory and the device system interface;
a local bus for data transfer between the device system interface and the device, whereby the local bus facilitates the direct movement of data and the data undergoes only a single DMA transfer; and
a driver that facilitates the transfer of data of arbitrary size between the system memory and the device without requiring all of the data of the same transaction to be received by the device system interface before the commencement of data transfer over the local bus or the system bus.

2. The communications system of claim 1 wherein, the device comprises more than one distinct device, each distinct device providing at least one further block of memory.

3. The communications system of claim 1 wherein, the remote device is a storage device.

4. The communications system of claim 3 wherein, the storage device comprises at least one storage sub-system, each storage sub-system providing at least one further block of memory.

5. The communications system of claim 1 wherein, the device is a separate computer system comprising a second system memory, and is further provided with a second device system interface with which the local bus can transfer data.

6. The communications system of claim 1 wherein, the device is provided as an external unit to the host computer system.

7. The communications system of claim 1 wherein, the device is provided as an internal unit to the host computer system.

8. The communications system of claim 1 wherein, the driver facilitates the transfer of data between:
relevant sections of the system memory and relevant sections of the device; and
separate blocks of memory within the system memory and the device using DMA scatter gather lists.

9. The communications system of claim 1 wherein, the further block of memory is comprised of RAM memory.

10. The communications system of claim 4 wherein, each storage sub-system is recognized by the local bus as a unique storage unit.

11. The communications system of claim 1 wherein, the local bus can support a combination of multiple device system interface modules and multiple other devices.

12. The communications system of claim 1 wherein, the local bus provides high-speed communication between the system memory and the device by having DMA combine data transfer and status reporting in one linked transaction.

13. The communications system of claim 3 wherein, the storage device is selected from the group consisting of magnetic media and silicon media.

14. The communications system of claim 1 wherein, the local bus provides communication between remote memory blocks that have dedicated channels for transmission of data in each direction.

15. The communications system of claim 1 wherein, the system bus utilizes the fastest available data transfer channel.

16. The communications system of claim 1 wherein, the system bus is selected from the group consisting of a PCI bus, a PCIX bus, a NGIO bus, an Infiniband bus, and other compatible system I/O buses.

17. The communications system of claim 1 wherein, the device system interface translates system bus signals to local bus signals to accommodate a difference in signalling standards.

18. The communications system of claim 17 wherein, the signalling standards comprise voltage regulation, memory addressing, and cycle timing.

19. A device for the high-speed direct movement of data of arbitrary size between remote blocks of memory within the device and a system memory provided by a host computer system, comprising:
at least one block of memory, the block of memory being remote from the block of memory provided by the system memory;
a device system interface capable of being connected to a system bus of the host computer system to provide for the transfer of data between the system memory and the device system interface;
a local bus for data transfer between the device system interface and a block of memory of the device, whereby the local bus facilitates the direct movement of data and the data undergoes only a single DMA transfer.

20. The device of claim 19 wherein, the host computer system is provided with a driver that facilitates the transfer of data of arbitrary size between the system memory and a block of memory of the device without requiring all of the data of the same transaction to be received by the device system interface before the commencement of data transfer over the local bus or the system bus.

21. The device of claim 19 wherein, the device is a storage device provided with at least one storage sub-system, each sub-system further provided with a memory storage means.

22. The device of claim 19 wherein, the device is a PCI add-in card.

23. The device of claim 19 wherein, the device is provided external to the host computer system.

24. A device for the high-speed direct movement of data between a block of memory within the device and a system memory housed in a host computer system, the device being external to the host computer system, communicating with the system memory by installation of a PCI adapter card within the host computer system, comprising:
a power supply module, further comprising an un-interruptible power supply module;
a memory, control and I/O module, providing a DRAM storage array, LVDS interface, IDE interface, system control, and error management;
a HDD archive module which communicates with the memory, control and I/O module via the IDE interface; and
a display module for indicating the status of the device.

25. The device of claim 24 wherein, the DRAM storage array of the memory, control and I/O module comprise DIMM modules and a DMA controller, the DMA controller providing for DIMM selection, address generation, ECC bit generation, ECC bit checking and bit correction, and writing and reading to and from the memory array.

26. The device of claim 24 wherein, the system control of the memory, control and I/O module further provides for data transfer to the HDD, detection of error conditions, collection and display of status information, and system testing and diagnosis.
